(19) United States
(12) Patent Application Publication
(10) Pub. No.: US 2025/0302021 A1
(43) Pub. Date: Oct. 2, 2025

(54) FISHING ROD

(71) Applicant: GLOBERIDE, INC., Higashikurume-shi (JP)

(72) Inventor: Shintaro NAKAGAWA, Higashikurume-shi (JP)

(73) Assignee: GLOBERIDE, INC., Higashikurume-shi (JP)

(21) Appl. No.: 18/950,747

(22) Filed: Nov. 18, 2024

(30) Foreign Application Priority Data
Mar. 26, 2024 (JP) 2024-048896

(51) Int. Cl. A01K 87/08; A01K 87/06

(52) U.S. Cl. CPC A01K 87/08; A01K 87/06

(57) ABSTRACT

In a fishing rod of the present invention, a grip 20 and a reel seat 10 are disposed adjacent to each other on an outer side of a base rod 2 and a ring member 30 is provided between the grip 20 and the reel seat 10. An extension portion 10a that protrudes in an axial direction is provided on an end surface of the reel seat 10, the end surface being adjacent to the grip 20, and a part of the grip 20 overlaps the extension portion 10a at an outer position in a radial direction, and the ring member 30 is interposed and fixed between the reel seat 10 and a part of the grip 20 on the extension portion 10a.

### CROSS-REFERENCE TO RELATED APPLICATION

This application claims priority under 35 U.S.C. § 119 to Japanese Patent Application No. 2024-048896 filed on Mar. 26, 2024 in the Japanese Patent Office, the entire contents of each hereby incorporated by reference.

### BACKGROUND OF THE INVENTION

### 1. Technical Field

The present invention relates to a fishing rod, and more particularly to a fishing rod having a feature in a grip portion to be gripped during actual fishing.

### 2. Description of the Related Art

As a fishing rod, for example, as disclosed in JP 2020-48451 A, a fishing rod in which a reel seat and a grip are adjacently fixed to an outer peripheral surface of a rod (base rod) is known. Usually, the reel seat is formed of a hard resin, the grip is formed of a soft material (EVA, cork, or the like), and a decorative ring member is interposed between the reel seat and the grip. In the reel seat disclosed in JP 2020-48451 A, an annular protrusion extending in an axial direction is formed on an end surface on the grip side, and the ring member is externally fitted and fixed on the protrusion.

### SUMMARY OF THE INVENTION

The fishing rod described above has a feature of being greatly curved (bent) at the time of actual fishing. As described above, when the fishing rod is greatly curved, the grip portion having low bending rigidity with respect to the reel seat tends to be curved following the rod, so that a gap is generated between the reel seat having high rigidity and the soft grip. When such a gap is generated, there are problems such as ingress of moisture and deterioration of hand contact.

The present invention has been made in view of the above problems, and an object of the present invention is to provide a fishing rod in which a ring member is attached between a grip and a reel seat that are fixed to a base rod, in which a gap is not generated in an arrangement portion of the ring member.

In order to achieve the above-described object, a fishing rod according to an aspect of the present invention is configured such that a grip and a reel seat are disposed adjacent to each other on an outer side of a base rod and a ring member is provided between the grip and the reel seat, in which an extension portion that protrudes in an axial direction is provided on an end surface of the reel seat, the end surface being adjacent to the grip, and a part of the grip overlaps the extension portion at an outer position in a radial direction, and the ring member is interposed and fixed between the reel seat and a part of the grip on the extension portion.

In the fishing rod with the above-described configuration, the extension portion is formed, on the end surface of the reel seat to protrude in the axial direction, the end surface being adjacent to the grip. A part of the grip overlaps the extension portion at an outer position in the radial direction, and the ring member interposed between the reel seat and a part of the grip is in a state of abutting a part of the grip at the outer position in the radial direction where a part of the grip overlaps the extension portion. Therefore, even when the base rod is largely curved and the grip portion is curved following the base rod, curving is suppressed by the extension portion of the reel seat having high bending rigidity, and the ring member provided on the extension portion is prevented from separating from the grip to generate a gap.

According to the present invention, in a fishing rod in which a ring member is attached between a grip and a reel seat that are fixed to a base rod, a gap is not generated in an arrangement portion of the ring member.

### BRIEF DESCRIPTION OF THE DRAWINGS

FIG. 1 is a perspective view illustrating a first embodiment of a fishing rod according to the present invention and illustrating a reel seat and a grip portion attached to a base rod portion;

FIG. 2 is a side view illustrating the base rod portion illustrated in FIG. 1, and an enlarged sectional view of a main portion;

FIG. 3 is a view illustrating a second embodiment of a fishing rod according to the present invention, and is a sectional view illustrating an arrangement state of a reel seat, a grip, and a ring member; and

FIG. 4 is a view illustrating a third embodiment of a fishing rod according to the present invention, and is a sectional view illustrating an arrangement state of a reel seat, a grip, and a ring member.

### DETAILED DESCRIPTION

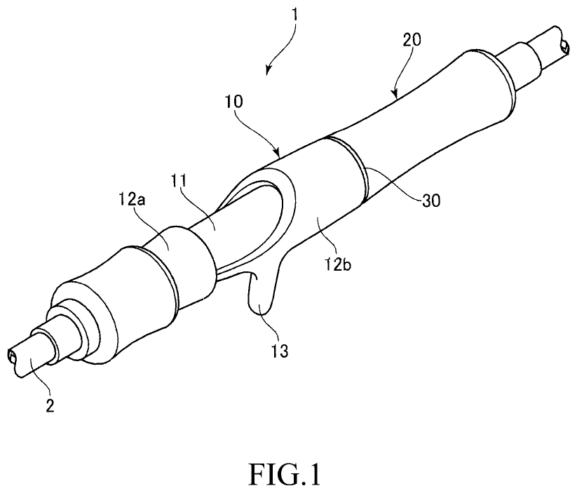

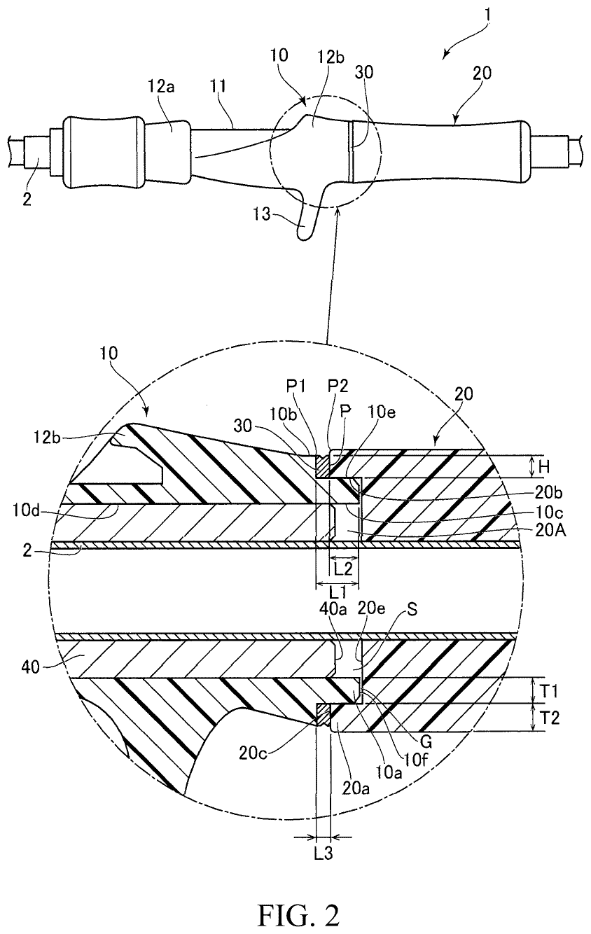

Hereinafter, embodiments of a fishing rod according to the present invention will be described. FIGS. 1 and 2 are views illustrating a first embodiment of a fishing rod according to the present invention, FIG. 1 is a perspective view illustrating a reel seat and a grip portion attached to a base rod portion of a fishing rod, and FIG. 2 is a side view of the base rod portion and an enlarged sectional view of a main portion.

The configuration of a fishing rod 1 of the present invention is not limited, and comprises a plurality of rods having a joining structure, a single rod, and the like, and the rod may be any of a tubular body, a solid body, and a combination thereof. In addition, the joining structure of the plurality of rods is not limited to the swinging type, the parallel joining type, the socket-and-spigot joining type, and the like, and the number of joining is also not limited.

A known reel seat 10 to which a double-bearing reel and a spinning reel are attached is provided in a rod (base rod) 2 constituting the fishing rod 1, and a fishing line guide (not illustrated) for guiding a fishing line released from the reel attached to the reel seat is provided in each rod at a predetermined interval. The reel seat 10 is provided with a placement portion 11 on which a reel leg is placed, and a movable hood 12a and a fixed hood 12b that tighten and fix the front and rear of the reel leg. Note that the reel seat of the present embodiment is configured to mount a double-bearing reel, and a trigger 13 on which a finger can be hooked is integrally formed on the opposite side of the placement portion 11.

A grip 20 is provided adjacent to a rear side (rod butt side) of the reel seat 10, and a ring member 30 is interposed and fixed between the reel seat 10 and the grip 20 in order to improve decorativeness.

The rod 2 is configured as a tubular member, and as is known, is formed by winding a prepreg sheet in which reinforcing fibers are impregnated with a synthetic resin around a core metal, curing the synthetic resin by heat treatment, and then removing the core metal. The rod 2 has an outer peripheral surface formed in a straight shape along the axial direction, a tapered shape in which the base end side is gradually increased in diameter, or a combination thereof, and the prepreg sheet having a structure in which the rod itself can be bent when a load acts on the rod tip side is used. Then, an adhesive is applied to the outer peripheral surface of the rod 2 formed in this manner, the reel seat 10 and the grip 20 are press-fitted in the axial direction, and are bonded and fixed to the front surface thereof.

The reel seat 10 is integrally formed of a hard material, for example, polyamide, ABS, a fiber-reinforced resin, carbon, or the like. The grip 20 is formed of a soft material having lower bending rigidity and better grip comfort than the reel seat 10, for example, EVA (hardness of 60° to 90°; JIS K7215), a foam material such as urethane, cork, carbon, or the like. In addition, the ring member 30 is formed of a metal such as aluminum, SUS, or titanium, or a hard material such as carbon.

In addition, in the present embodiment, a spacer 40 is provided between the reel seat 10 and the rod 2 in order to adjust the diameter. The spacer 40 is formed of, for example, a foam material such as urethane or EVA, compressed cork, carbon, or the like, is externally fitted to the rod 2, and is fixed to the front surface of the rod and the inner surface of the reel seat 10 using an adhesive.

In the above-described configuration, the grip 20 adjacent to the reel seat 10 is configured such that a gap is not generated at a boundary portion between the ring member 30 and the grip 20 when the rod 2 is bent.

Hereinafter, a first embodiment of a fishing rod having such a structure will be described. The reel seat 10 is provided with an extension portion 10a protruding in the axial direction on an end surface (rear end surface) adjacent to the grip 20. The extension portion 10a is formed in an annular shape protruding toward the rear side in the axial direction at a position recessed in a radial direction from a front surface 10b on the rear end side of the reel seat 10. In this case, an inner surface 10c of the extension portion 10a is formed to be flush with an inner surface 10d of the reel seat 10, and an outer surface 10e of the extension portion 10a is formed at a position recessed by a height H with respect to the front surface 10b.

The ring member 30 is externally fitted and bonded to the extension portion 10a. In addition, a part of the grip 20 engages with the outer surface 10e of the extension portion 10a and abuts on the ring member 30 externally fitted to the extension portion 10a. Specifically, a part of the grip 20 overlaps the extension portion 10a at an outer position in the radial direction, and the ring member 30 is interposed and fixed between the reel seat 10 and a part of the grip 20 on the extension portion 10a. Therefore, a position P where the ring member 30 abuts on a part of the grip 20 is configured to be closer to the reel seat side than an end surface 10f on the rear side of the extension portion 10a.

In the present embodiment, an annular recessed portion (hereinafter, referred to as an annular recessed portion 20A) surrounded by an annular wall portion (annular wall 20a) when the grip is viewed from the axial direction is formed on an end surface of the grip 20 on the reel seat side. The extension portion 10a of the reel seat is fixed to an inner surface 20b of the annular wall 20a forming the annular recessed portion 20A. Therefore, the ring member 30 is fixed in a state of being interposed between the reel seat 10 and an end surface 20c of the wall portion 20a which is a part of the grip.

According to the above configuration, even when the rod 2 is largely curved at the time of actual fishing and the portion of the grip 20 is curved following the rod 2, curving is suppressed by the relationship with the reel seat 10 having high bending rigidity, and the ring member 30 is prevented from separating from the grip 20 to generate a gap.

That is, even when the rod 2 is largely curved and the grip portion is curved following the rod 2, the reinforcing effect of the grip can be obtained by the extension portion 10a of the reel seat 10, and the grip can be prevented from being curved. As a result, the ring member 30 provided in the extension portion 10a is prevented from separating from the grip 20 (the end surface 20c of the wall portion 20a) to generate a gap, and ingress of moisture and visual recognition of the extension portion 10a from the outside are reliably prevented.

In the present embodiment, the annular recessed portion 20A is formed in the grip 20, and the extension portion 10a is fixed to the inner surface 20b of the wall portion 20a, so that the assembling work can be easily performed and the axial dimension can be suppressed.

In the above configuration, it is preferable to use the ring member 30 of which the outer diameter is equal to or smaller than the outer diameter of the adjacent reel seat 10 and the outer diameter of the grip 20. That is, it is preferable to use the ring member 30 of which the front surface has a size to be on the inner side of a rear end position P1 of the reel seat 10 and a front end position P2 of the grip 20 in the radial direction.

According to such a configuration, the gap at the boundary portion between the ring member 30 and the reel seat 10 and the gap at the boundary portion between the ring member 30 and the grip 20 can be made difficult to see, and the appearance can be improved. In addition, since the ring member 30 does not protrude outward in the radial direction, fingers will not get caught and the ring member 30 does not get in the way during operation.

It is preferable that an axial length L1 from a distal end (end surface 10f on the rear side) of the extension portion 10a is secured to be equal to or greater than 4.5 mm. In addition, an axial length L2 from the distal end (end surface 10f on the rear side) of the extension portion 10a to the position P where the ring member 30 abuts on a part of the grip 20 is preferably equal to or greater than 3.5 mm and is equal to or less than the axial length L1 of the extension portion 10a.

As described above, by securing the axial length L1 of the extension portion 10a of 4.5 mm or more and the length L2 up to the position where the ring member abuts on the grip of at least 3.5 mm equal to or less than the length L1, it is possible to effectively suppress the generation of the gap as described above in a general fishing rod in which the ring member 30 is provided between the reel seat and the grip.

As described above, since the reel seat 10 is formed of a material having high bending rigidity and the grip 20 is formed of a material having lower bending rigidity than the that of the reel seat 10, the thickness of each portion is preferably set within an appropriate range so as to obtain the above-described action and effect.

Specifically, the thickness T1 of the extension portion 10a is preferably formed within a range of 1.0 to 3.5 mm, and the thickness T2 of the wall portion 20a of the grip 20 is preferably formed within a range of 2.0 to 4.0 mm. As a result, even when bending (bending stress) acts on the rod 2, it is possible to effectively suppress generation of a gap at the boundary portion between the ring member 30 and the grip 20. Note that the thickness T2 of the wall portion 20a of the grip 20 may be made thinner than the thickness T1 of the extension portion 10a as long as the bending strength of carbon or the like is high.

In addition, the ring member 30 having an axial length L3 equal to or less than the axial length L1 of the extension portion 10a is used. For example, it is preferable to use the axial length L3 of 0.5 to 2.5 mm so that generation of a gap can be effectively suppressed. Note that the height (depression amount) H of the outer surface 10e of the extension portion 10a and the front surface 10b of the extension portion is not particularly limited, and can be variously changed according to the thickness of the ring member 30 to be mounted and the axial length L3.

In the present embodiment, as described above, the spacer 40 is provided between the reel seat 10 and the rod 2. The spacer 40 may be in contact with the grip 20, but is preferably disposed to form a gap S surrounded by an end surface 40a of the spacer, the end surface (bottom surface of the recessed portion) 20e of the grip 20, and the inner surface 10c of the extension portion 10a. The gap S is formed in the annular recessed portion 20A.

As described above, when the spacer 40 is disposed, by forming the gap S, it is possible to prevent stress from acting on the extension portion 10a even when the rod is bent. In addition, the presence of the gap S eliminates the need for strict dimensional control, and it is not necessary to form a relief on the grip 20 side, and an efficient structure can be achieved. Furthermore, since the adhesive can be collected at the time of assembly, the manufacturing process is facilitated. The gap G may be set to be generated between the end surface 10f on the rear side of the extension portion 10a and the bottom surface 20e of the annular recessed portion 20A so as to facilitate the manufacturing process.

Next, other embodiments of the present invention will be described. In the embodiments described below, portions similar to those of the above-described first embodiment are denoted by the same reference numerals, and detailed description thereof will be omitted.

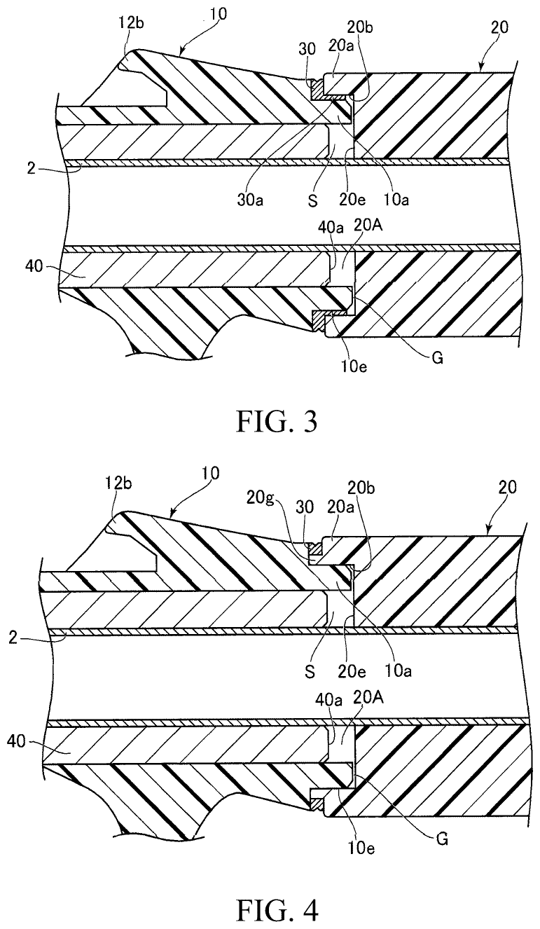

FIG. 3 is a view illustrating a second embodiment, and is a sectional view illustrating an arrangement state of the reel seat, the grip, and the ring member. In this embodiment, a protrusion (annular protrusion) 30a extending in the axial direction is formed in an opening region of the ring member 30, and the protrusion 30a is bonded to be interposed between the extension portion 10a and a part of the grip 20 (the inner surface 20b of the wall portion 20a).

According to such a configuration, since the reinforcing effect of the grip is enhanced by the extension portion 10a of the ring member 30 formed of a hard material, it is possible to more effectively suppress the curve of the grip.

FIG. 4 is a view illustrating a third embodiment, and is a sectional view illustrating an arrangement state of the reel seat, the grip, and the ring member. In this embodiment, a step portion 20g is formed on the reel seat side of the wall portion 20a of the grip 20, and the ring member 30 is fixed on the step portion 20g. That is, the ring member 30 is interposed between the reel seat 10 and the grip 20, and is fixed so as not to be in direct contact with the extension portion 10a.

Even in such a configuration, even when the rod 2 is greatly curved and the grip portion tries to be curved following the rod 2, the curve of the grip 20 can be suppressed, and the ring member 30 can be prevented from separating from the step portion 20g to generate a gap.

The embodiments of the present invention have been described above, but the present invention is not limited to the above-described embodiments and may be modified in various ways. For example, shapes, lengths, materials, and the like of the reel seat 10 and the grip 20 can be appropriately modified. The ring member 30 described above may be disposed between the reel seat 10 and the grip disposed on the front side of the reel seat 10.

The ring member 30 may have a structure in which a groove or a recessed portion is formed on the rear end surface of the reel seat 10 and the ring member 30 is locked to the groove or the recessed portion. In addition, in the configuration of the above-described embodiment, the extension portion 10a and the wall portion 20a are formed in an annular shape continuous over 360°, but these may not be continuous annular, and may be formed at regular intervals in the circumferential direction, or formed with slits or notches along the axial direction.

Furthermore, in the above-described embodiments, the ring member 30 is interposed between the reel seat 10 and the grip 20, but the reel seat 10 and the grip 20 may be directly brought into contact with each other without disposing such a ring member 30. Even with such a structure, by fixing the extension portion 10a to the inner surface 20b of the wall portion 20a of the annular recessed portion 20A of the grip 20, it is possible to suppress generation of a gap in the contact portion of both members even when the rod is bent.

### REFERENCE SIGNS LIST

1 fishing rod
2 base rod (rod)
10 reel seat
10a extension portion
20 grip
30 ring member

What is claimed is:

1. A fishing rod in which a grip and a reel seat are disposed adjacent to each other on an outer side of a base rod and a ring member is provided between the grip and the reel seat,
wherein an extension portion that protrudes in an axial direction is provided on an end surface of the reel seat, the end surface being adjacent to the grip, and
a part of the grip overlaps the extension portion at an outer position in a radial direction, and the ring member is interposed and fixed between the reel seat and a part of the grip on the extension portion.

2. The fishing rod according to claim 1, wherein
an annular recessed portion is formed on an end surface on the reel seat side of the grip,
the extension portion is fixed to an inner surface of a wall portion forming the annular recessed portion, and
the ring member is interposed between the reel seat and an end surface of the wall portion.

3. The fishing rod according to claim 2, wherein
a step portion is formed on the reel seat side of the wall portion, and
the ring member is fixed on the step portion.

4. The fishing rod according to claim 1, wherein
a protrusion that extends in an axial direction is formed on the ring member, and
the protrusion is interposed between the extension portion and a part of the grip.

5. The fishing rod according to claim 1, wherein
the extension portion has an axial length of 4.5 mm or more from a distal end, and
an axial length from the distal end of the extension portion to a position where the ring member abuts on a part of the grip is equal to or less than the axial length of the extension portion and is equal to or greater than 3.5 mm.

6. The fishing rod according to claim 1, wherein an outer diameter of the ring member is equal to or less than an outer diameter of the adjacent reel seat and an outer diameter of the grip.

7. The fishing rod according to claim 1, wherein
a spacer is interposed between the base rod and the reel seat, and
the spacer is disposed to form a gap surrounded by an end surface of the spacer, an end surface of the grip, and an inner surface of the extension portion.
